(19) United States
(12) Patent Application Publication
(10) Pub. No.: US 2008/0065753 A1
(43) Pub. Date: Mar. 13, 2008

(54) Electronic Device Management

(76) Inventor: Bindu Rama Rao, Laguna Niguel, CA (US)

Correspondence Address: MCANDREWS HELD & MALLOY, LTD, 500 WEST MADISON STREET, SUITE 3400, CHICAGO, IL, 60661, US

(21) Appl. No.: 11/847,658

(22) Filed: Aug. 30, 2007

Related U.S. Application Data
(60) Provisional application No. 60/841,425, filed on Aug. 30, 2006.

(51) Int. Cl. G06F 15/173

(52) U.S. Cl. 709/223

(57) ABSTRACT

One disclosed embodiment of an electronic device includes an electronic device comprising an interface for communicating with at least one remote server, and one or more processors operably coupled to the interface and to memory, the one or more processors operable to, at least, access at least one device management object in memory of the electronic device according to a device management protocol standard, in response to one or messages from the at least one server; create a snapshot of dynamic operating parameters of the electronic device in the memory, using the at least one device management object.

The present application makes reference to, claims priority to, and claims benefit of U.S. Provisional Application Ser. No. 60/841,425 entitled “DEVICE AND NETWORK CAPABLE OF MOBILE DIAGNOSTICS BASED ON DIAGNOSTIC FUNCTIONS, TRAPS AND EVENTLOGS” (Attorney Docket No. 18154US01), filed Aug. 30, 2006, the complete subject matter of which is hereby incorporated herein by reference, in its entirety.

In addition, the present application makes reference to U.S. Provisional Patent Application Ser. No. 60/785,879, entitled “Device And Network Capable Of Mobile Diagnostics Based On Diagnostic Management Objects” (Attorney Docket No. 101USMD145), filed Mar. 24, 2006, U.S. Provisional Patent Application Ser. No. 60/249,606, entitled “System and Method for Updating and Distributing Information,” filed Nov. 17, 2000, and International Patent Application Publication No. WO 02/41147 A1, entitled “System And Method For Updating And Distributing Information”, filed Nov. 19, 2001, and having publication date Mar. 23, 2002, the complete subject matter of each of which is hereby incorporated herein by reference, in its entirety.

### BRIEF DESCRIPTION OF SEVERAL VIEWS OF THE DRAWINGS

FIG. 1 is a perspective block diagram of an exemplary network that supports remote diagnosis of an electronic device using diagnostics management objects in the electronic device, wherein executables may be downloaded and installed on the electronic device to monitor applications and diagnose problems, in accordance with a representative embodiment of the present invention.

FIG. 2 is a perspective block diagram showing the structure of an exemplary “DevSnapshot” management object (MO) that supports retrieval of a snapshot of dynamic data in an electronic device such as, for example, the electronic device of FIG. 1, in accordance with a representative embodiment of the present invention.

FIG. 3 is a perspective block diagram illustrating the structure of another exemplary “DevSnapshot” management object implemented as a “DiagnosticFunction” MO instance, in accordance with a representative embodiment of the present invention.

FIG. 4 is a perspective block diagram showing the structure of an exemplary “EventLogs” MO that supports the logging of events of various categories in an electronic device such as, for example, the electronic device of FIG. 1, in accordance with a representative embodiment of the present invention.

FIG. 5 is a perspective block diagram illustrating the structure of an exemplary “CallHandlingEventsLogs” MO that supports management of the logging activities associated with call handling events and the retrieval of such logs in an electronic device such as, for example, the electronic device of FIG. 1, in accordance with a representative embodiment of the present invention.

FIG. 6 is a perspective block diagram showing the structure of an exemplary “DroppedCallTrap” MO that supports monitoring dropped call events, in which a “ToRef” node of the “DroppedCallTrap” MO refers to a corresponding “DroppedCall” MO to enable the logging and subsequent retrieval of dropped calls information, in accordance with a representative embodiment of the present invention.

FIG. 7 shows a perspective block diagram illustrating the structure of an exemplary “GenDataServicesEventLogs” MO that supports logging of events associated with generic data services, in accordance with a representative embodiment of the present invention.

FIG. 8 is a perspective block diagram showing the structure of an exemplary “AppFaultLogging” MO that supports logging of events associated with application software in an electronic device such as, for example, the application software in the electronic device of FIG. 1, and in particular, with respect to events related to faults or exceptions encountered by application software in an electronic device, in accordance with a representative embodiment of the present invention.

FIG. 9 shows a perspective block diagram illustrating the structure of an exemplary “DevStaticInfo” MO that supports the remote retrieval of relatively static diagnostic data associated with an electronic device such as, for example, the electronic device of FIG. 1, in accordance with a representative embodiment of the present invention.

FIG. 10 is a flowchart of an exemplary method of operating an electronic device to support management by at least one remote server, in accordance with a representative embodiment of the present invention.

### DETAILED DESCRIPTION OF THE INVENTION

Aspects of the present invention relate generally to the updating of memory in electronic devices, and more specifically, to devices, servers, and methods supporting remote device management of electronic devices. Device management may comprise, for example, the processing and distribution of updates for firmware, software, configuration parameters and file systems in memory of an electronic device such as, for example, non-volatile FLASH-type memory. While the following discussion focuses primarily on mobile electronic devices such as, for example, a mobile handset, a cellular phone, a personal digital assistant, a pager, and a handheld personal computer, this is by way of example and not by way of specific limitations of the present invention. The teaching contained herein may also be applicable to a variety of other electronic devices having a processor and memory containing software, firmware, configuration information, data files, and the like, for which updating of memory contents may be desirable.

Representative embodiments of the present invention may be employed during updates using wired or wireless communication links such as, for example, a public switched telephone network, a wired local or wide area network, a wired wide area network, an intranet, the Internet, and wireless cellular, paging, local area, personal area, short range, broadcast, metropolitan access, and/or multipoint networks such as those wireless networks referred to as Wi-Fi networks, IEEE 802.11 a/b/g/n compatible networks, networks referred to as WiMax networks, IEEE 802.16d/e networks, the short range wireless technology known as Bluetooth, and similar types of communication links.

In a representative embodiment of the present invention, information for updating memory in an electronic device such as those described above is communicated using, for example, an update package comprising a set of instructions executable by firmware and/or software in the electronic device to transform or convert an existing version of software, firmware, and/or data in the electronic device into a new or updated version of the software, firmware, and/or data. Such an update package may also contain metadata related to the update.

The following definitions, acronyms and abbreviations are use in this document:

| | |
|---|---|
| API | Application Programming Interface |
| CP | Client Provisioning |
| CSR | Customer Service Representative |
| DAO | Data Access Objects |
| DM | Device Management |
| DM Tree | Device management tree |
| GPRS | General Packet Radio Service |
| IMEI | International Mobile Equipment Identity |
| MMV | Refers to a combination of values that define a device make, |
| | model and (firmware) version |
| MO | Management Object |
| NVM | Non-Volatile Memory |
| OMA | Open Mobile Alliance |
| RAM | Random Access Memory |
| SMS | Short Message Service |
| SMSC | Short Message Service Center |
| UI | User Interface |
| URI | Universal Resource Identifier |
| URL | Universal Resource Locator |

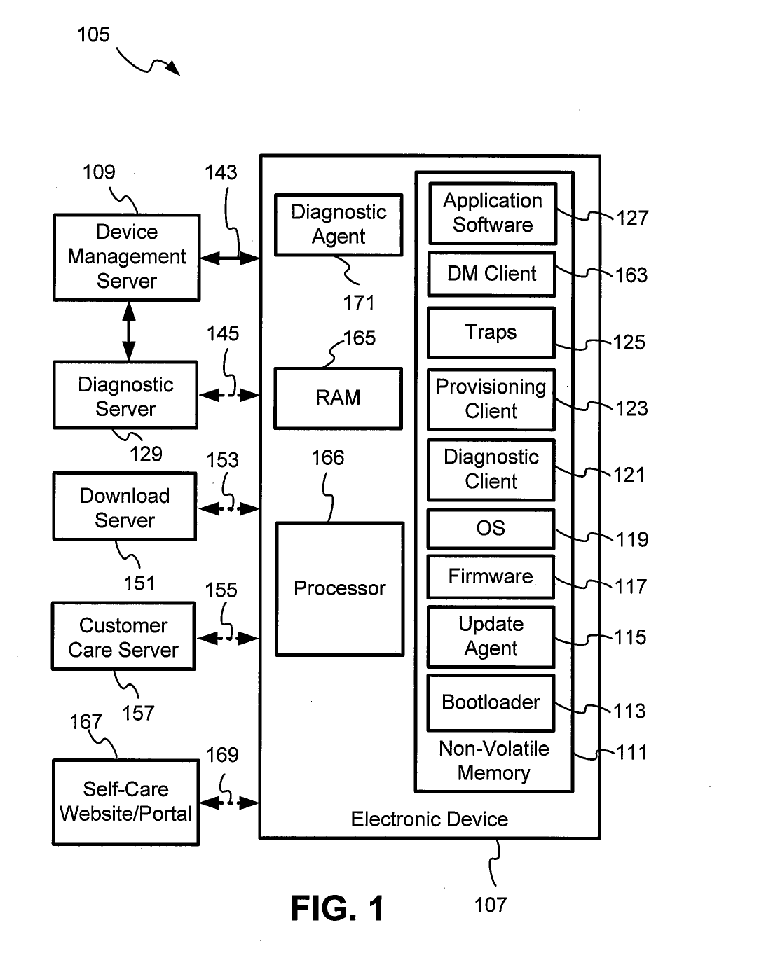

FIG. 1 is a perspective block diagram of an exemplary network 105 that supports remote diagnosis of an electronic device 107 using diagnostics management objects in the electronic device 107, wherein executables may be downloaded and installed on the electronic device 107 to monitor applications and diagnose problems, in accordance with a representative embodiment of the present invention. The electronic device 107 may, for example, comprise a cellular phone, a personal digital assistant (PDA), a pager, a handheld personal computer (PC), and/or the like. The electronic device 107 may support a number of features and/or applications that may contain software/firmware errors that need to be corrected, or that may provide additional features/benefits by updating the software/firmware. The electronic device 107 may itself be used to request customer care service, including updates to software/firmware, via a customer care server 157. This may be accomplished either directly, using a browser in the electronic device 107, or via a customer service representative (CSR). A CSR may, for example, provide service to the customer using the electronic device 107 by retrieving, as necessary, one or more diagnostic management objects (MOs) stored in memory of the electronic device 107, and by transmitting to the electronic device 107 from a remote server, update information in the form of, for example, one or more update packages. Such update packages may, for example, comprise instructions to code in the electronic device 107 to convert or transform a first version of software/firmware to a second version of software/firmware, in the electronic device 107, in addition to metadata, and checksum information.

As shown in the illustration of FIG. 1, the network 105 in one representative embodiment of the present invention comprises the electronic device 107, a device management (DM) server 109, a self-care website/portal 167, a diagnostic server 129, a customer care server 157, and a download server 151. In one representative embodiment of the present invention, the diagnostic server 129 is an application which receives, processes, and stores/presents the information obtained from the electronic device 107 in an easily readable fashion. The diagnostic server 129 may comprise a personal computer (PC) used by a user to accept collected tracing information from the electronic device 107 through a USB connection, a Bluetooth® connection or via an secure digital format (SD) card (e.g., when a wireless data service for over-the-air (OTA) transfer of data is unavailable). A representative embodiment of the present invention may also comprise other application servers. The electronic device 107 of FIG. 1 is able to communicate with the DM server 109, the download server 151, the customer care server 157, the self-care website/portal 167, and the diagnostic server 129 via communication paths 143, 153, 155, 169, and 145, respectively. Although the communication paths 143, 153, 155, 169, 145 are illustrated as being separate paths between the electronic device 107 and their respective servers, this is only for purpose of illustration, and is not a specific limitation of a representative embodiment of the present invention. The communication paths 143, 153, 155, 169, 145 may be combined into one or more paths that may comprise any of the wired or wireless networks previously mention above, including point-to-point and/or broadcast, wired or wireless communication paths such as, for example, a local area network, a public switched telephone network, a wireless personal, local or wide area network, and a cellular or paging network, to name only a few possibilities. Although not shown in the illustration of FIG. 1, the electronic device 107 also comprises interfaces used to communicate over the communications paths 143, 153, 155, 169, and 145, which have been omitted from the illustration solely to improve clarity to aid in understanding the figure.

As illustrated in FIG. 1, an electronic device in accordance with one representative embodiment of the present invention comprises a processor 166, random access memory (RAM) 165, and non-volatile memory (NVM) 111. The NVM 111 may comprise, for example, NAND or NOR type flash memory or other suitable type of NVM. The NVM 111 may contain a number of software/firmware code components of the electronic device 107 including, for example, application software 127, a device management (DM) client 163, a traps client 125, a provisioning client 123, a diagnostic client 121, an operating system (OS) 119, firmware 117, one or more update agent(s) 115, and a bootloader 113. Additional software/firmware code components may also be present in the RAM 165 and NVM 111. The term “code” may be used herein to represent one or more of executable instructions, operand data, configuration parameters, and other information stored in memory of the electronic device 107, and the term “update package catalog” may be used interchangeably with the term “update package array” to refer to received update information that comprises multiple update packages. The term “application software” or “software application” may be used herein to refer to code that provides functionality apparent to the user of the electronic device 107, as opposed to that code in the electronic device that supports application software such as, for example, an operating system, a file system, software support for communications protocols, and the like. Application software includes, for example, Internet web browsers, calendars and/or contact managers, and software for engaging in a particular user or enterprise task, to name just a few examples. The electronic device 107 may also comprise interface circuitry (not shown) to enable operable connection of a subscriber identity module (SIM) card, that may be employed in accordance with aspects of the present invention described in this document.

In one representative embodiment of the present invention, an electronic device such as, for example, the electronic device 107 of FIG. 1 employs an update package (not shown, stored in RAM 165 or NVM 111) delivered by a remote server such as, for example, the download server 151, to update firmware/software, data and configuration information in memory of the electronic device 107. Such an update package comprises update information including, for example, metadata describing an update, checksums, and instructions executable by one or more update agents such as, for example, the update agent 115 of FIG. 1. The update agent 115 processes a set of executable instructions, which are used as a compact means to encode differences between existing/first and updated/second versions of firmware, software, data, and configuration parameters for the electronic device 107. The executable instructions may be assembled into update packages to be transmitted to the electronic device 107 for use in updating memory of the electronic device 107. One or more update agent(s) 115 in the electronic device 107 process respective portions of the executable instructions from an update package to convert/transform corresponding portions of an existing/first version of code in memory (e.g., RAM 165 and/or NVM 111) of the electronic device 107 to portions of an updated/second version of code. The electronic device 107 may also receive provisioning information from, for example, the device management server 109, the customer care server 157, the diagnostic server 129, and/or a provisioning server to fix configuration problems or reconfigure software and hardware.

As shown in FIG. 1, the electronic device 107 may comprise a diagnostic client 121 that facilitates remote diagnosis. The diagnostic client 121 may have been installed at the time of manufacture of the electronic device 107, or be downloaded at a later time using a wired or wireless link of the electronic device 107. The electronic device 107 may also comprise a diagnostic agent 171 that runs on the electronic device 107 when required by conditions, or on a continuing basis to perform monitoring, and which manages and collects tracing information for transmission to a server such as, for example, diagnostic server 129 using a cellular data network part of communication path 145. The electronic device 107 of FIG. 1 also comprises a traps client 125 that facilitates the setting of traps and retrieving of collected information. The term “trap” may be used herein to refer to an action taken outside of operation of the electronic device for its intended use, by executable code in the electronic device 107 (e.g., the traps client 125) when one or more specified conditions are met. Traps can be used to collect data such as errors, faults encountered while operating the mobile device 107, network performance data, and call setup data, to name just a few examples. Such conditions may be remotely defined by, for example, messages sent by a server such as the diagnostic server 121 or DM server 109, for example. In one representative embodiment of the present invention, the traps client 125 and the diagnostic agent 171 are combined into one embedded diagnostic client component capable of supporting traps as well as collecting diagnostic data and configuration information for eventual transfer to the diagnostic server 129 or the customer care server 157.

The DM client 163 of the electronic device 107 may interact with the DM server 109, the diagnostic client, and the traps client 125, to receive DM commands from the DM server 109 and to implement them in the electronic device 107. The download server 151 may be employed to download firmware and software updates (e.g., update information in the form of, for example, update packages). The download server 151 may also be used to download new firmware/software such as, for example, the diagnostics client mentioned above, which may then be installed and activated in the electronic device 107. The bootloader 113 may be employed at power-up or device reset to move executable code from, for example, the NVM 111, into RAM 165, for execution by processor 166.

As described briefly above, an electronic device in accordance with a representative embodiment of the present invention (e.g., electronic device 107) receives update information (e.g., an update package) for processing by one or more update agents (e.g., update agent 115) to convert/transform software (e.g., application software 127) and/or firmware (e.g., firmware 117) to produce updated software/firmware in the electronic device. In some representative embodiments of the present invention, the update agent 115 comprises multiple update agents, each of the update agents appropriately arranged to process different types of update information for updating different types/formats of software, firmware, user data, and configuration parameters in the memory of the electronic device 107. Each of the update packages received is processed in the electronic device by an appropriate one of the update agent(s) 115 to update an associated type of information in the memory of the electronic device 107.

In one representative embodiment of the present invention, an Open Mobile Alliance (OMA) device management (DM)-based applications server is composed of two parts, an OMA DM-based application, and an OMA DM server such as, for example, the DM server 109 shown in FIG. 1. An OMA DM-based application is mainly focused on business processes, logic, and data. Such an application may reside on any of the servers shown in FIG. 1, or on another server (not shown) that is in communication with a server of FIG. 1, such as, for example, the DM server 109. An OMA DM server, however, is mainly focused on the functionality used to support the OMA DM protocol by which the OMA DM-based application manipulates OMA DM-capable electronic devices such as, for example, the electronic device 107 of FIG. 1.

A customer care server such as, for example, the customer care server 157 of FIG. 1, may provide an application programming interface (API) for issuing OMA DM commands and values to OMA DM capable electronic devices, including the ability to explore the device management tree (DM tree) on the electronic device. Bootstrapping the electronic device may be supported, along with the ability to configure one or more bootstrap messages. A customer care server such as the customer care server 157 may support a simple graphical user interface (UI) to allow OMA DM compatible electronic devices to be bootstrapped, and for commands to be issued to allow the electronic device to be explored and configured via a browser such as, for example, an Internet browser.

In one representative embodiment of the present invention, the code to support OMA DM-based device management for customer care activities of a customer care server (e.g., customer care server 157 of FIG. 1) is shared with an OMA DM-based application server. Such a representative embodiment of the present invention helps a system operator to ensure that an application server and a customer care server produce identical behavior in their interactions with electronic devices under OMA DM-based device management.

An OMA DM common framework in accordance with one representative embodiment of the present invention provides for the real-time sharing of data by multiple OMA DM Based applications, and may include sharing of the data from a DM tree in an electronic device such as the electronic device 107 of FIG. 1. In a representative embodiment of the present invention, each OMA DM-based application may access the data used to create OMA DM commands for the electronic device 107.

Currently, each manufacturer of an electronic device such as the electronic device 107 of FIG. 1 may place electronic device setting parameters (e.g., GPRS setting) in different locations within the DM tree of an electronic device they manufacture. This may cause the node uniform resource identifier (URI) of a given parameter to be different for each electronic device make, model, and version (MMV). Some representative embodiments of the present invention provide a data store to be used in managing DM tree information. Such a data store may hold single device information such as the international mobile equipment identity (IMEI) of the electronic device, a password, and a nonce, to name only a few examples. Some data may be customized for each OMA DM-based application including, for example, the type of authentication scheme to be used, and bootstrap content. Some representative embodiments of the present invention allow a user of a customer care system to modify the bootstrap content, to specify the security type and profile type for devices. The security type may, for example, be one or both of “Networkpin” and “Userpin”. Some representative embodiments of the present invention permit notification and bootstrap functionality to be shared by OMA DM-based customer care and application servers such as the customer care server 157 and DM server 109 of FIG. 1, for example. Such an arrangement permits a user of the customer care server to specify, for example, a short message service center (SMSC) to be used for the sending of notification and bootstrap messages. Some representative embodiments of the present invention provide this functionality through a set of APIs and call back services that support the sending of DM commands and receipt of results.

A DM server such as, for example, the DM server 109, in a representative embodiment of the present invention employs management objects (MOs) to enable electronic device management operation such as, for example, storing information, retrieving information, and activating or invoking functionality in the electronic device 107, to name only a few operations. Managements objects and their nodes and sub-nodes of representative embodiments of the present invention are extensions to those defined by a device management protocol such as, for example, the Open Mobile Alliance (OMA) device management (DM) V1.2 protocol, developed under the direction of the Open Mobile Alliance, Ltd. For example, in a representative embodiment of the present invention, a DM server (e.g., the DM server 109) sends one or more commands to a DM client (e.g., the DM client 163) of an electronic device (e.g., the electronic device 107), instructing the DM client 163 in the electronic device 107 to set identified management objects in a management tree stored in memory (e.g., non-volatile memory) of the electronic device 107 to a particular value. The management objects managed by the DM server 109 and the DM client 163 of the electronic device 107 may, for example, direct the electronic device 107 to store parameters in a particular parameter/variable, fetch the value of a particular parameter/variable, execute code in the electronic device 107 to perform diagnostic functionality in the electronic device 107, or to return results of previous diagnostic activity to a server.

As described briefly above, the network 105 of FIG. 1 is able to conduct remote diagnostics on the electronic device 107. This is desirable when a user of the electronic device 107 experiences operational issues that he/she cannot resolve. Some operational anomalies may be resolve by analysis of settings in the electronic device 107, which may be retrieved by the customer care server 155 and/or the diagnostic server 129, for example. In some situations, a customer care representative may employ a representative embodiment of the present invention to download and install executable code in the electronic device 107, to actively monitor applications and diagnose problems.

In a representative embodiment of the present invention, the electronic device 107 may be used to request customer care service via a customer care server 157. During such activities, device capability information may be provided to the customer care server 157, or other server, for example. A customer service representative (CSR) in communication with the customer care server 157 provides service to the customer using the electronic device 107, after reviewing/analyzing the device capability information retrieved from the electronic device 107. This makes it unnecessary for a customer to provide such information himself to a CSR, and avoids errors. In this manner, the network 105 of a representative embodiment of the present invention supports performance of remote diagnostics by a CSR, using a server having the functionality of the customer care server 157 of FIG. 1.

In a representative embodiment of the present invention, the customer care server 157 or DM server 109 also supports diagnostic data collection requests from a diagnostic server such as the diagnostic server 129 of FIG. 1, and the return of collected diagnostics data to the diagnostics server 129. Diagnostics data collected by the electronic device 107 may be sent in either push or pull mode by the electronic device 107 to any authorized server in the network 105.

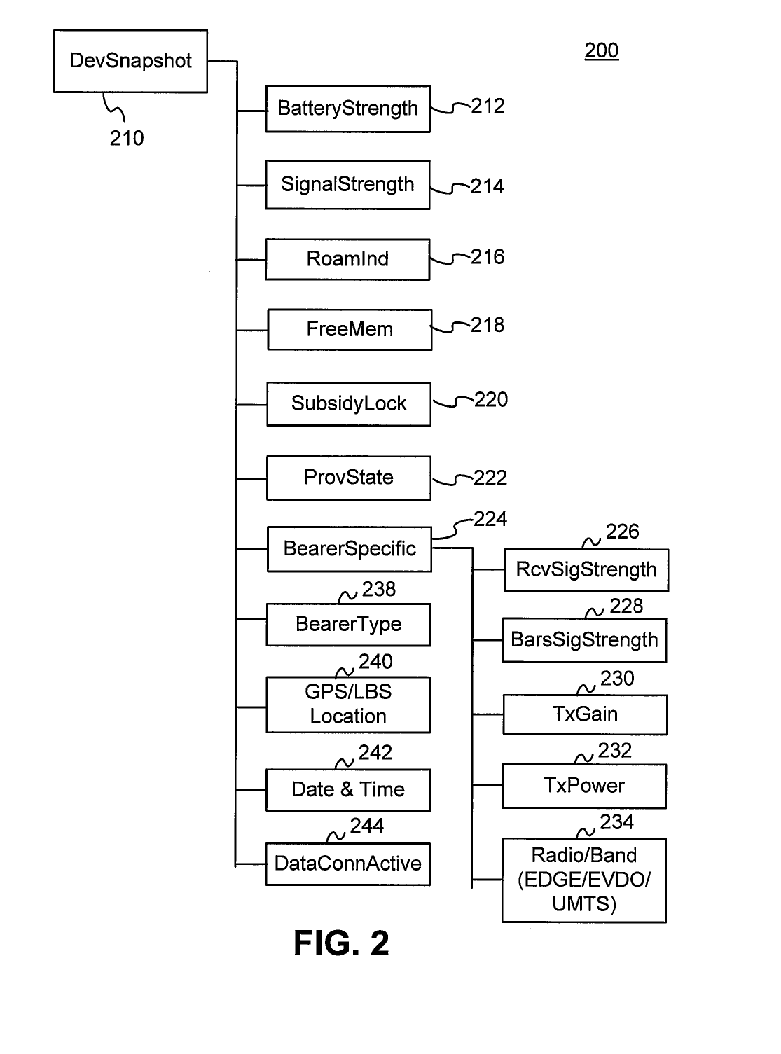

FIG. 2 is a perspective block diagram showing structure the structure of an exemplary snapshot device management object (MO) “DevSnapshot” 210 that supports retrieval of a snapshot or sampling of one or more dynamic data items in an electronic device such as, for example, the electronic device 107 of FIG. 1, in accordance with a representative embodiment of the present invention. As shown in the example of FIG. 2, such a device management object may comprise one or more individual dynamic operating parameters or variables measured and/or determined by an electronic device such as the electronic device 107 of FIG. 1. The example of FIG. 2 illustrates a “BatteryStrength” node 212 that may reflect the current state of the battery of the electronic device 107, a “SignalStrength” node 214 that may represent the level of the signal presently being received from the serving wireless network, and a “Roamind” node 216 that reflects whether the electronic device 107 is in a roaming situation. The snapshot device management object “DevSnapshot” 210 of FIG. 2 also comprises a “FreeMem” node 218 used to indicate the amount of free memory that is currently available in the electronic device 107, a “SubsidyLock” node 220 that indicates whether or not the cost to the user of the electronic device 107 is subsidized by a provider serving the electronic device 107, and a “ProvState” node 222 that indicates whether or not the electronic device 107 has been provisioned for operation, or for the use of a particular service.

In a representative embodiment of the present invention, a snapshot MO such as the snapshot device management object “DevSnapshot” 210 of FIG. 2 may also comprise a “BearerSpecific” node 224 that may be used to access dynamic operating parameters that are particular to a specific communication carrier or “bearer”. The example of FIG. 2 shows that the “BearerSpecific” node 224 includes a “RcvSigStrength” sub-node 226 whose value indicates the magnitude of the signal presently received by the electronic device 107, a “BarsSigStrength” sub-node 228 that reflects the signal strength as present on the display of the electronic device 107, a “TxGain” sub-node 230 that reflects the current transmit gain setting of the electronic device, a TxPower” sub-node 232 that may indicate the power class of the electronic device 107, and a “Radio/Band” sub-node 234 that indicates, for example, the radio frequency band currently in use (e.g., 800 MHz, 900 MHz, 1.8 GHz) and the current operating mode (e.g., EDGE (Enhanced Data Rates for Global Evolution), EvDO (Evolution-Data Optimized), and UMTS (Universal Mobile Telephone Service)). These exemplary sub-nodes are, as the node name suggests, bearer specific, and may be determined by the type of communication path to which they apply.

In addition to those information elements described above, a representative embodiment of a snapshot device management object in accordance with the present invention, as shown in the example of FIG. 2, may also comprise a “BearerType” node 238 that indicates the type of the communication link in use (e.g., cellular (e.g., CDMA, TDMA, GSM, iDen), WiFi (i.e., IEEE 802.11 a/big/n), WiMax (i.e., IEEE 802.16 a/b), or another form of wired or wireless communication link). The “DevSnapshot” MO 210 may also comprise a global positioning system (GPS)/location-based services (LBS) location node “GPS/LBSLocation” 240 that indicates the current geographic position of the electronic device 107, a “Date&Time” node 242 that reflects the current date and time at the location of the electronic device 107, and a “DataConnActive” node 244 that indicates whether the electronic device 107 is currently being used for the exchange of user data.

It will be recognized by one of skill in the art that the nodes and sub-nodes of the snapshot device management object “DevSnapshot” 210 of FIG. 2 are for illustrative use only and do not represent specific limitations of a representative embodiment of the present invention.

In a representative embodiment of the present invention, a server such as, for example, the DM server 109, diagnostic server 129 and/or customer care server 157 of FIG. 1 may access nodes within the snapshot device management object “DevSnapshot” 210 of FIG. 2 using, for example, an Open “Get” operation such as that supported by the Open Mobile Alliance (OMA) device management (DM) V1.2 protocol, to retrieve a particular snapshot of one parameter value. In another case, such a server may retrieve values for all of the parameters in the portion of the device management tree that reside within the snapshot device management object “DevSnapshot” 210 of FIG. 2.

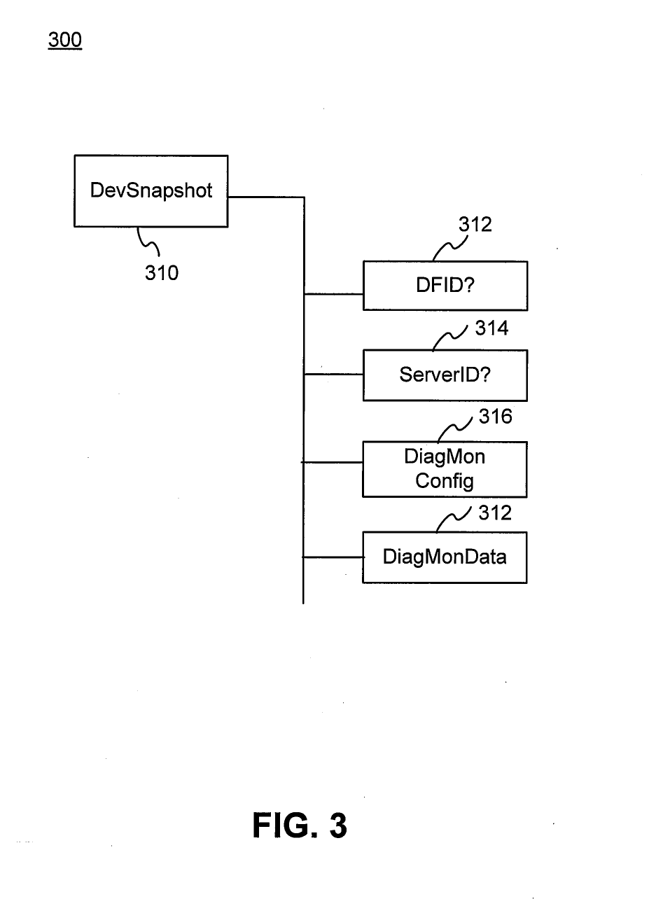

FIG. 3 is a perspective block diagram illustrating the structure of another exemplary “DevSnapshot” MO 310 implemented as a “DiagnosticFunction” MO instance, in accordance with a representative embodiment of the present invention. As shown in the example of FIG. 3, such a device management object may comprise one or more individual operation parameters or variables measured and/or determined by an electronic device such as the electronic device 107 of FIG. 1. The example “DevSnapshot” MO 310 of FIG. 3, however, offers additional functionality above that of the example snapshot device management object “DevSnapshot” 210 of FIG. 2. The example of FIG. 3 illustrates a “DFID” node 312 that identifies a diagnostic function available in the electronic device 107. The diagnostic function ID (DFID) node 312 permits remote activation of the executable code of a diagnostic function in the electronic device 107, enabling a remote server such as, for example, the diagnostic server 129 or DM server 109 to initiate diagnostics and/or the collection of operating parameters, in the electronic device 107. The diagnostic function accessible via the “DFID” node 312 may be made available during manufacture of the electronic device 107, or may be downloaded and installed after manufacture.

As illustrated in FIG. 3, the “DevSnapshot” MO 310 may also comprise a “ServerID” node 314 that identifies a remote server such as, for example, the diagnostic server 129, customer care server 157, or DM server 109 that is permitted/authorized to request/initiate diagnostic activities in the electronic device 107. In some representative embodiments of the present invention, a “DiagMon” node 316 may be employed to indicate how results of diagnostic activities are to be reported. In some representative embodiments, results may be stored in, for example, a node such as the “DiagMonData” node 312 of FIG. 3, while in other representative embodiments, the results may be returned to a server (e.g., the diagnostic server 129, customer care server 157, DM server 109, or another server accessible by the electronic device 107) via a communication link. If stored in a node such as the “DiagMonData” node 312 of FIG. 3, the results information may be retrieved using, for example, an OMA DM “Get” operation. Similar to the snapshot device management object “DevSnapshot” 210 of FIG. 2, the values stored within the “DevSnapshot” MO 310 and its nodes/sub-nodes may be retrieved one at a time by accessing the individual nodes/sub-node, or all at once by accessing the “DevSnapshot” MO 310. If the results from initiation of the diagnostic function of the “DFID” node 312 were stored in the “DiagMonData” node 312, those result may be retrieved at a later time, using the same mechanism used to retrieve any of the nodes/sub-nodes of the device management tree in which the “DevSnapshot” MO 310 resides.

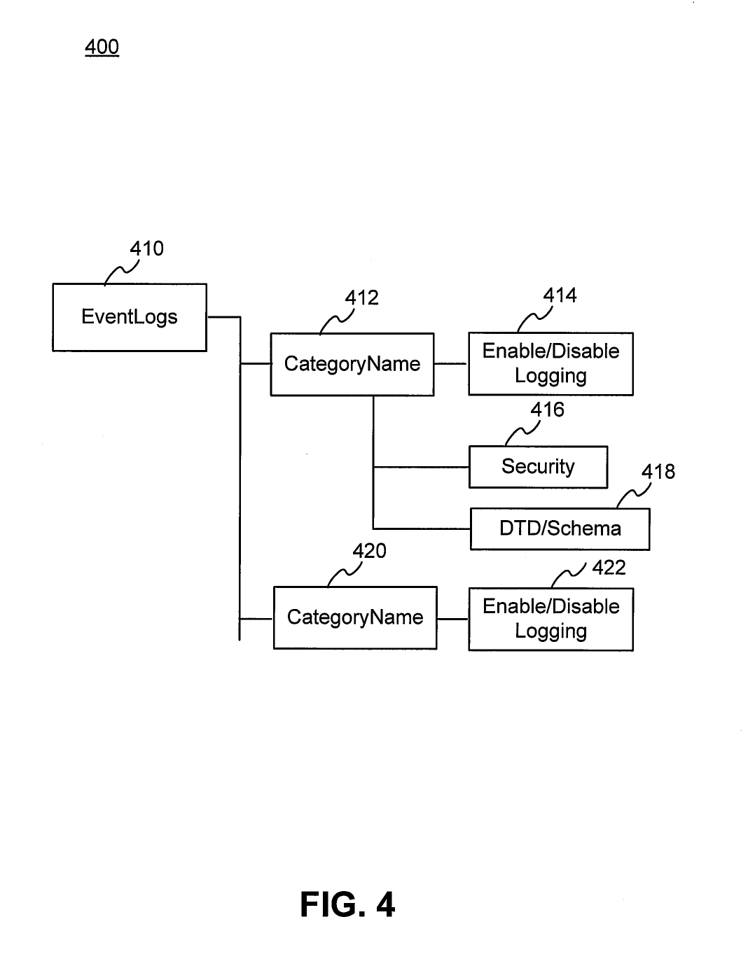

FIG. 4 is a perspective block diagram showing the structure of an exemplary generic “EventLogs” MO 410 that supports the logging of events of various categories in an electronic device such as, for example, the electronic device 107 of FIG. 1, in accordance with a representative embodiment of the present invention. As illustrated in the example of FIG. 4, such a device management object may comprise one or more individual dynamic operating parameters or variables, or grouped structures of parameters or variables measured and/or determined by an electronic device, such as the electronic device 107 of FIG. 1. The example “EventLogs” MO 410 illustrated in FIG. 4 comprises two nodes—a “CategoryName” node 412 and a “CategoryName” node 420, that are generic examples of nodes used to organize and access operating parameters by categories such as, for example, those related to connections established by the electronic device 107, those related to call handling activities of the electronic device 107, those related to the operation of application software on the electronic device 107, and those related to “re-starts” or “reboots” experienced by the electronic device 107. It should be apparent to one of skill in the art that operating parameters and variables in an electronic device such as the electronic device 107 of FIG. 1 may be categorized or grouped in many different ways, and that the example of FIG. 4 is for the purpose of illustration and does not represent a specific limitation of the present invention.

As can be seen in FIG. 4, the “CategoryName” node 412 comprises sub-node “Enable/DisableLogging” 414 that permits event logging for the related category to be enabled and disabled. The “CategoryName” node 412 also has a “Security” sub-node 416 that may be used to enable/disable encryption of log information and parameters related to the act of checking server authorization to access log information. The example of FIG. 4 also shows that the “CategoryName” node 412 has a “DTD/Schema” sub-node 418 that may be employed to store a data type definition (DTD) or extensible markup language (XML) schema used in the processing/formatting of information exchanged between the electronic device 107 and a remote server such as, for example, the diagnostic server 129, customer care server 157, or DM server 109.

The illustration of FIG. 4 also shows a “CategoryName” node 420 that comprises a single sub-node “Enable/DisableLogging” 422 that permits event logging for events in the related category to be enabled and disabled.

It should be noted that while the example of FIG. 4 illustrates a generic “EventLogs” node 410 having two generic category nodes “CategoryName” node 412 and “CategoryName” node 420, other events logs and categories may be defined, without departing from the scope of the present invention. It should be apparent to one of skill in the art upon appreciating the teachings set forth herein that the nodes/sub-nodes of the “EventLogs” node 410 of FIG. 4 may be accessed/retrieved one at a time, or as a larger collection, depending upon how this portion of a device management tree is accessed.

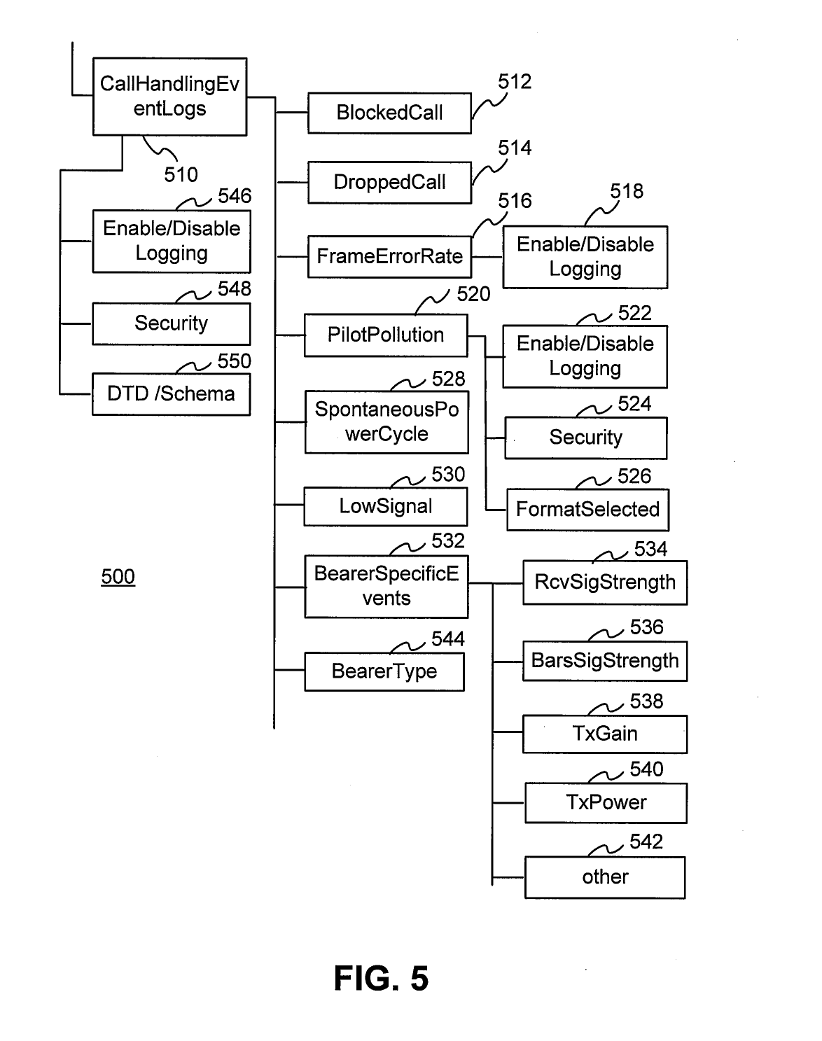

FIG. 5 is a perspective block diagram illustrating the structure of an exemplary “CallHandlingEventsLogs” MO 510 that supports management of the logging activities associated with call handling events and the retrieval of such logs in an electronic device such as, for example, the electronic device 107 of FIG. 1, in accordance with a representative embodiment of the present invention. The “CallHandlingEventsLogs” MO 510 is an example of one category of events that may be logged in an electronic device such as, for example, the electronic device 107 of FIG. 1. As can be seen in the illustration of FIG. 5, the exemplary “CallHandlingEventsLogs” MO 510 comprises a number of nodes/sub-nodes directly related to the category of “call handling events”, and some nodes/sub-nodes that are relevant to all event logs. The “CallHandlingEventsLogs” MO 510 of FIG. 5 comprises a “BlockedCall” node 512 for logging call attempts that were blocked, a “DroppedCall” node 514 for logging active calls that were dropped unintentionally, and a “FrameErrorRate” node 516 to log errors in speech or data frames. The “CallHandlingEventsLogs” MO 510 of FIG. 5 also comprises a “PilotPollution” node 520 to log occurrences of pilot pollution, a “SpontaneousPowerCycle” node 528 to log power cycling not requested by the user, a “LowSignal” node 530 to log situations where received signal levels dropped below a threshold, and a “BearerSpecific” node 532 with sub-nodes 534, 536, 538, 540, and 542, and “BearerType” node 544, that are akin to the “BearerSpecific” node 224 and “BearerType” node 238, of FIG. 2. In addition, the “CallHandlingEventsLogs” MO 510 of FIG. 5 comprises an “Enable/DisableLogging” node 546, a “Security” node 548, and a “DTD/Schema” node 550, analogous to the “Enable/DisableLogging” sub-node 414, “Security” sub-node 416, and “DTD/Schema” sub-node 418, of FIG. 4.

In a representative embodiment of the present invention, a server such as, for example, the customer care server 157, the diagnostic server 129, and/or the DM server 109 of FIG. 1 can conduct an device management “Get” operation on the “CallHandlingEventsLogs” MO 510 of FIG. 5 to retrieve log entries for all parameters in a category, or to retrieve a particular parameter from the logs. As described, a representative embodiment of the present invention also supports enabling/disabling the logging of specific parameters.

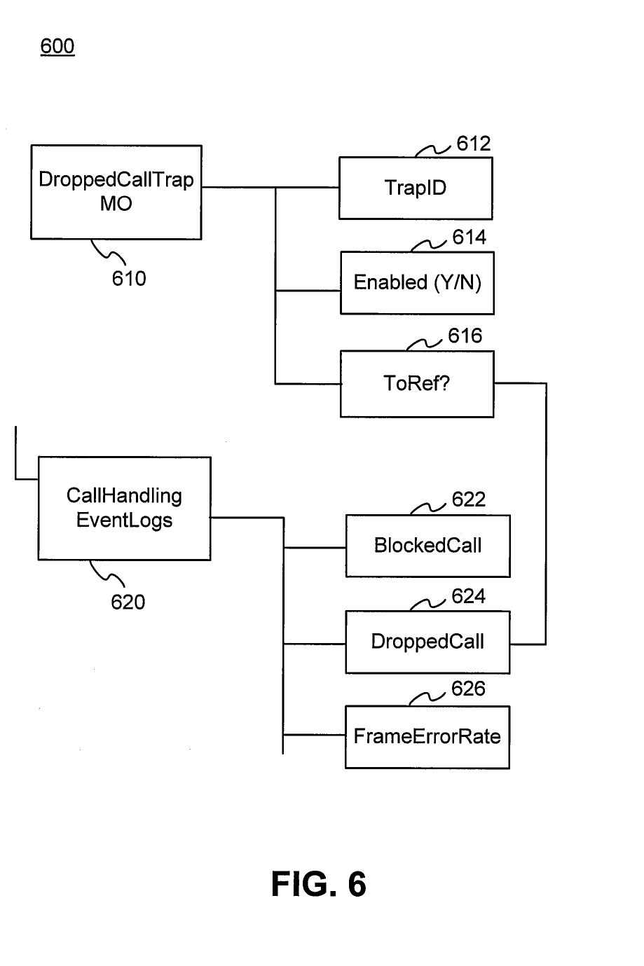

FIG. 6 is a perspective block diagram showing the structure of an exemplary “DroppedCallTrap” MO 610 that supports monitoring dropped call events, in which a “ToRef” node 616 of the “DroppedCallTrap” MO 610 refers to an associated “DroppedCall” MO 624 to enable the logging and subsequent retrieval of dropped calls information, in accordance with a representative embodiment of the present invention. As illustrated in the example of FIG. 6, the “DroppedCallTrap” MO 610 comprises a “TrapID” node 612 providing an identifier for the trap, an “Enabled(Y/N)” node 614 that controls/reflects the state of activation of the trap, and in this example, a “ToRef” node 616 that refers to the log used to store the occurrence of the “DroppedCallTrap”. The “CallHandlingEventLogs” MO 620 of FIG. 2 may correspond to, for example, the “CallHandlingEventLogs” MO 510 of FIG. 5. FIG. 6 illustrates that, in some representative embodiments of the present invention, an instance of a Trap MO may refer to an “EventLogs” MO or, for example, a sub-node within an “EventLogs” MO such as, for example, the generic “EventLogs” MO 410 of FIG. 4, or the specific example of the “CallHandlingEventsLogs” MO 510 of FIG. 5

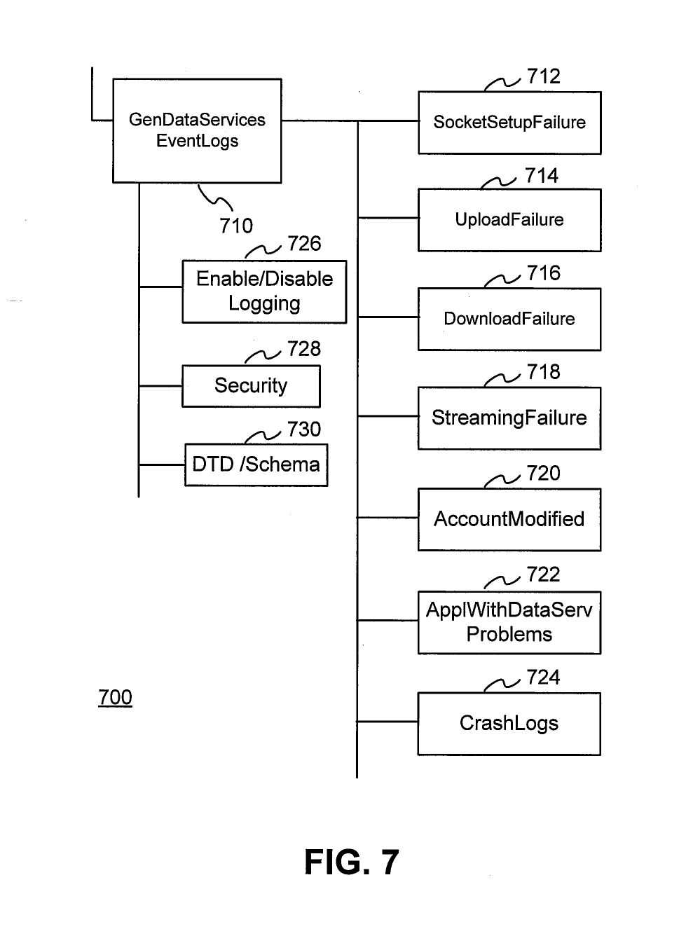

FIG. 7 is a perspective block diagram illustrating the structure of an exemplary “GenDataServicesEventLogs” MO 710 that supports logging of events associated with generic data services, in accordance with a representative embodiment of the present invention. As shown in the illustration of FIG. 7, one representative embodiment of the present invention comprises a “SocketSetupFailure” node 712 that logs the context when a socket setup failure occurred, an “UploadFailure” node 714 that records the context when an upload failure occurred, a “DownloadFailure” node 716 to record the context when a download failure occurred, a “StreamingFailure” node 718 to record the context of a streaming link failure, an “AccountModified” node 720 to record pertinent information when modifications of an account used for voice/data/wireless access occurred, an “ApplWithDataServProblems” node 722 to log problem counts for loss of data service, and a “CrashLogs” node 724 to record failures of applications.

In addition, the “GenDataServicesEventsLogs” MO 710 of FIG. 7 comprises an “Enable/DisableLogging” node 726, a “Security” node 728, and a “DTD/Schema” node 730, analogous to the “Enable/DisableLogging” sub-node 414, “Security” sub-node 416, and “DTD/Schema” sub-node 418, of FIG. 4. Of course, it will be recognized by one of skill in the art upon reading and understanding this disclosure, that the particular nodes/sub-nodes and uses or behavior described above are for illustrative purposes only, and do not represent any specific limitations of the present invention.

In a representative embodiment of the present invention, a server such as, for example, the customer care server 157, the diagnostic server 129, and/or the DM server 109 of FIG. 1 can conduct an device management “Get” operation on the “GenDataServicesEventsLogs” MO 710 of FIG. 7 to retrieve log entries for all parameters in a category, or to retrieve a particular parameter from the logs. As described, a representative embodiment of the present invention also supports enabling/disabling the logging of specific parameters.

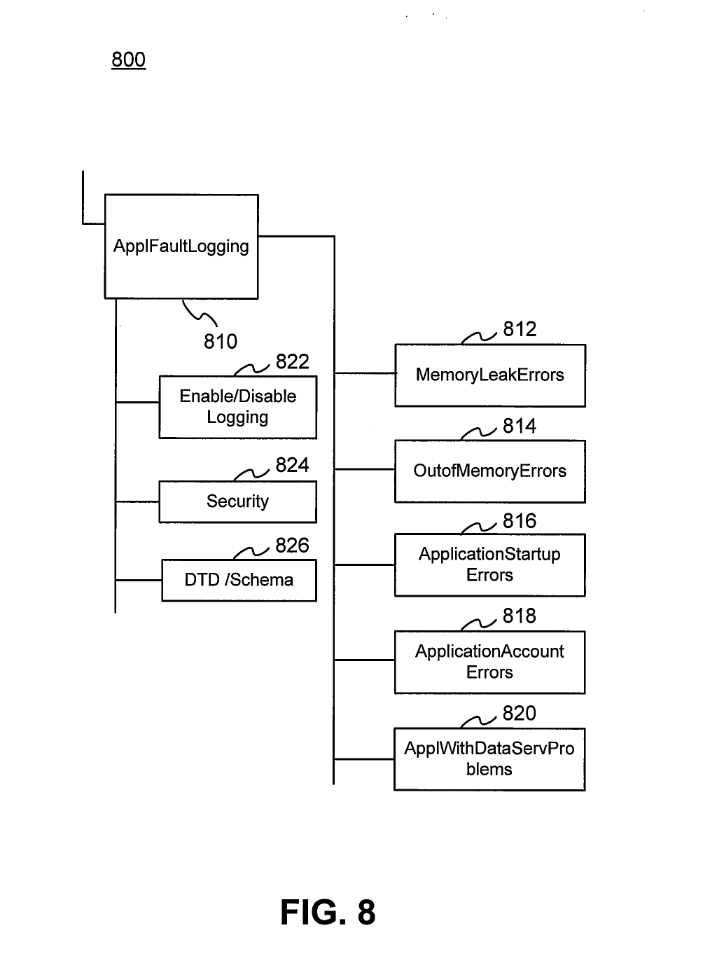

FIG. 8 is perspective block diagram showing the structure of an exemplary “AppFaultLogging” MO 810 that supports logging of events associated with application software in an electronic device such as, for example, the application software 127 in the electronic device 107 of FIG. 1, and in particular, with respect to events related to faults or exceptions encountered by application software in an electronic device, in accordance with a representative embodiment of the present invention. As the illustration of FIG. 8 shows, one representative embodiment of the present invention comprises a “MemoryLeaksErrors” node 812 that logs detected memory leaks, an “OutOfMemoryErrors” node 814 that records the occurrence of an out-of-memory condition, and an “ApplicationStartupErrors” node 816 that logs errors that occur during the startup of application software such as, for example, the application software 127 of FIG. 1. The “AppFaultLogging” MO 810 shown in FIG. 8 also comprises an “ApplicationAccountErrors” node 818 that logs errors related to a subscriber account used by application software on the electronic device 107, and an “ApplWithDataServProblems” node 820 used to record the occurrence of problems related to loss of data services in use by application software such as, for example, the application software 127 of FIG. 1.

As illustrated in FIG. 8, the “AppFaultLogging” MO 810 comprises an “Enable/DisableLogging” node 822, a “Security” node 824, and a “DTD/Schema” node 826 in accordance with similarly named nodes described above with respect to FIG. 4. One of skill in the art will immediately recognize after considering the teachings contained herein, that the element names and arrangement of elements shown in FIG. 8 described above are for illustrative purposes only, and do not represent any specific limitations of the present invention.

In a representative embodiment of the present invention, a server such as, for example, the customer care server 157, the diagnostic server 129, and/or the DM server 109 of FIG. 1 may conduct a device management “Get” operation on the “AppFaultLogging” MO 810 of FIG. 8 to retrieve log entries for all parameters in a category, or to retrieve a particular parameter from the logs. As described previously, although not shown in FIG. 8, a representative embodiment of the present invention also supports enabling/disabling the logging of specific parameters.

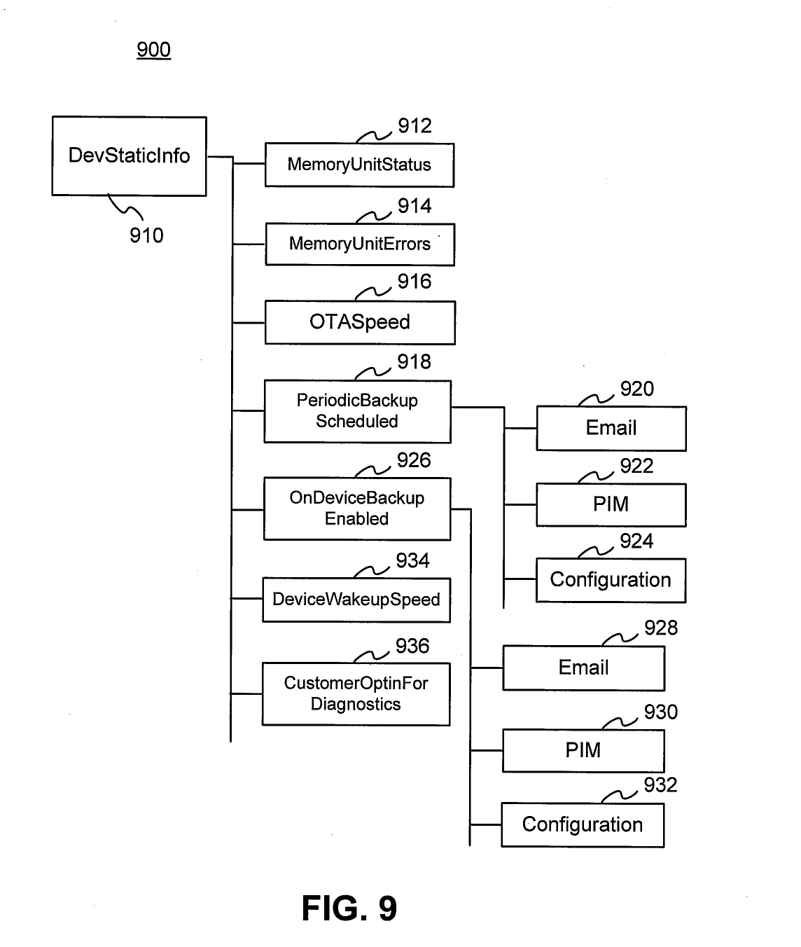

FIG. 9 shows a perspective block diagram illustrating the structure of an exemplary “DevStaticInfo” MO 910 that supports the remote retrieval of relatively static diagnostic data associated with an electronic device such as, for example, the electronic device 107 of FIG. 1, in accordance with a representative embodiment of the present invention. The “DevStaticInfo” MO 910 of FIG. 9 comprises a “MemoryUnitStatus” node 912 that may be retrieved to determine the status (e.g., size, whether or not presence, type of memory) of a memory unit of the electronic device 107, a “MemoryUnitErrors” node 914 indicating the number of errors detected in a memory unit on the electronic device 107, and an “OTASpeed” node 916 that enables the remote determination of the data rate of over-the-air (OTA) transfers of data by the electronic device 107. The “DevStaticInfo” MO 910 in the example of FIG. 9 also comprises a “PeriodicBackupScheduled” node 918, comprising “Email” sub-node 920, “personal information manager” (PIM) sub-node 922, and “Configuration” sub-node 924 that indicate whether periodic backup of email, personal data (e.g., calendar, to-do list, notes, address book/contacts), and configuration information of the electronic device 107 is scheduled, respectively.

As illustrated in FIG. 9, one representative embodiment of the present invention comprises an “OnDeviceBackupEnabled” node 926 having an “Email” sub-node 928, a “PIM” sub-node 930, and a “Configuration” sub-node 932 that reflect whether email, personal data, and configuration information is to be backed-up when a backup of the electronic device 107 is performed. The structure of the “DevStaticInfo” MO 910 of FIG. 9 also includes a “DeviceWakeupSpeed” node 934 that indicates, for example, the time the electronic device 107 takes to become operational once it is powered up or following a re-boot, and a “CustomerOptinForDiagnostics” node 936 used to remotely determine whether the owner/user of an electronic device 107 that is not subsidized permits the downloading/installation/performance of diagnostic functions on the electronic device 107.

In a representative embodiment of the present invention, a server such as, for example, the customer care server 157, the diagnostic server 129, and/or the DM server 109 of FIG. 1 may conduct a device management “Get” operation on the “DevStaticInfo” MO 910 of FIG. 9 to retrieve static information for all parameters in a category, or to retrieve the value of a particular static parameter.

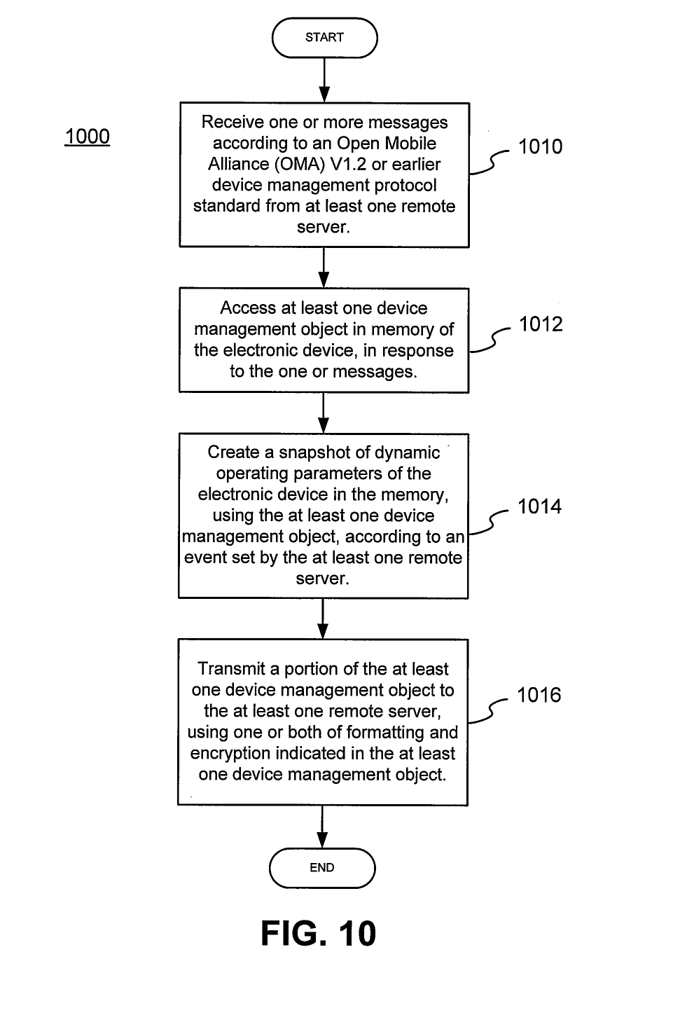

FIG. 10 is a flowchart of an exemplary method of operating an electronic device to support management by at least one remote server, in accordance with a representative embodiment of the present invention. The following description regarding the method of FIG. 10 makes reference to the elements of FIG. 1. The method of FIG. 10 begins, at block 1010, when an electronic device such as, for example, the electronic device 107 receives one or more messages according to an Open Mobile Alliance (OMA) V1.2 or earlier device management protocol standard from at least one remote server. The remote server sending the messages may correspond to, for example, the diagnostic server 129, the customer care server 157, and/or the device management server 109. Next, at block 1012, the electronic device accesses at least one device management object in memory of the electronic device, in response to one or messages of the received messages. Examples of some of the device management objects that may be accessed are shown in FIGS. 2 through 9. At block 1014, the electronic device 107 then creates a snapshot of dynamic operating parameters of the electronic device in the memory, using the at least one device management object, according to an event set by the at least one remote server. The memory may, for example, comprise a device management tree in the NVM 111 of the electronic device 107. The electronic device 107 may then, at block 1018, transmit a portion of the at least one device management object to the at least one remote server, using one or both of formatting and encryption indicated in the at least one device management object. Indications of formatting and encryption may be found, for example, in the “DiagMonConfig” node 316 of the “DevSnapshot” MO 310 shown in FIG. 3, or in sub-nodes such as the “Security” sub-node 416 and “DTD/Schema” sub-node 418 shown in FIG. 4. The server receiving the snapshot information may then process it to determine the state of conditions at the electronic device, using the formatting and encryption information settings used by the electronic device.

Although a system and method according to the present invention has been described in connection with the preferred embodiment, it is not intended to be limited to the specific form set forth herein, but on the contrary, it is intended to cover such alternative, modifications, and equivalents, as can be reasonably included within the scope of the invention as defined by this disclosure and appended diagrams.

Accordingly, a representative embodiment of the present invention may be realized in hardware, software, or a combination of hardware and software. Representative embodiments of the present invention may be realized in a centralized fashion in at least one computer system, or in a distributed fashion where different elements are spread across several interconnected computer systems. Any kind of computer system or other apparatus adapted for carrying out the methods described herein is suited. A combination of hardware and software may be a general-purpose computer system with a computer program that, when being loaded and executed, controls the computer system such that it carries out the methods described herein.

A representative embodiment of the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While aspects of the present invention have been described with reference to certain embodiments, it will be understood by those skilled in the art that various changes may be made and equivalents may be substituted without departing from the scope of the representative embodiments of the present invention. In addition, many modifications may be made to adapt a particular situation or material to the teachings of a representative embodiment of the present invention without departing from its scope. Therefore, it is intended that embodiments of the present invention not be limited to the particular embodiments disclosed herein, but that representative embodiments of the present invention include all embodiments falling within the scope of the appended claims.

What is claimed is:

1. An electronic device comprising:
an interface for communicating with at least one remote server;
one or more processors operably coupled to the interface and to memory, the one or more processors operable to, at least:
access at least one device management object in memory of the electronic device according to a device management protocol standard, in response to one or messages from the at least one server;
create a snapshot of dynamic operating parameters of the electronic device in the memory, using the at least one device management object.

2. The device according to claim 1, wherein the at least one device management object is an extension to the device management protocol standard.

3. The device according to claim 1, wherein the at least one device management protocol standard is compatible with the Open Mobile Alliance (OMA) device management (DM) V1.2 or earlier protocol standard.

4. The device according to claim 1, wherein the creation of the snapshot is initiated by the occurrence of an event in the mobile electronic device.

5. The device according to claim 4, wherein the snapshot comprises information identifying the context of the event causing initiation of the snapshot.

6. The device according to claim 4, where the event initiating creation of the snapshot is set by the at least one remote server.

7. The device according to claim 1, wherein the interface enables wireless communication with the at least one remote server.

8. The device according to claim 1, wherein the snapshot of dynamic operating parameters is stored within the at least one device management object in the memory.

9. The device according to claim 1, wherein the snapshot of dynamic operating parameters is returned to the at least one remote server using a pull mechanism.

10. The device according to claim 1, wherein a format and/or content of the snapshot of dynamic operating parameters returned to the at least one remote server are specified employing an extensible markup language (XML) data type definition (DTD) or an XML schema.

11. The device according to claim 1, wherein the snapshot of dynamic operating parameters is created during communication of one or both of user voice and user data.

12. The device according to claim 1, wherein the at least one device management object enables the at least one remote server to determine whether the electronic device is subsidized by a provider of a communication service.

13. The device according to claim 1, wherein the at least one device management object enables the at least one remote server to determine whether the electronic device has been provisioned for service, and wherein being provisioned for service comprises being configured for use on a communication network.

14. The device according to claim 1, wherein the one or more processors are further operable to, at least:
receive information for updating the memory with executable code for causing the one or more processors to perform diagnosis of the electronic device, using the at least one device management object.

15. One or more servers supporting management of a remote electronic device, the one or more servers comprising:
at least one interface supporting communication with the remote electronic device; and
at least one processor communicatively coupled to the at least one interface and to storage, the at least one processor operable to, at least:
access at least one device management object in memory of the remote electronic device according to a device management protocol standard, the access enabling creation of a snapshot of dynamic operating parameters in the remote electronic device;
receiving the snapshot of dynamic operating parameters, using the at least one device management object; and
storing the snapshot of dynamic operating parameters in the storage.

16. The one or more servers according to claim 15, wherein the device management protocol standard is compatible with the Open Mobile Alliance (OMA) device management (DM) V1.2 or earlier protocol standard.

17. The one or more servers according to claim 15, wherein the at least one device management object is an extension to the device management protocol standard.

18. The one or more servers according to claim 15, wherein creation of the snapshot of dynamic operating parameters of the remote electronic device is initiated by an event set by the one or more servers.

19. The one or more servers according to claim 15, wherein the at least one processor is further operable to, at least:
access the at least one device management object to determine whether the remote electronic device is subsidized by a provider of a communication service;
perform diagnostics on the remote electronic device using the stored snapshot of dynamic operating parameters, if the remote electronic device is subsidized; and
refrain from performing diagnostic on the remote electronic device, if the remote electronic device is not subsidized.

20. A method of operating an electronic device to support management by at least one remote server, the method comprising:
receiving one or more messages according to an Open Mobile Alliance (OMA) V1.2 or earlier device management protocol standard, from the at least one remote server;
accessing at least one device management object in memory of the electronic device, in response to the one or messages;
creating a snapshot of dynamic operating parameters of the electronic device in the memory, using the at least one device management object, according to an event set by the at least one remote server; and
transmitting a portion of the at least one device management object to the at least one remote server, using one or both of formatting and encryption indicated in the at least one device management object.
